(19) United States
(12) Patent Application Publication
(10) Pub. No.: US 2008/0137901 A1
(43) Pub. Date: Jun. 12, 2008

(54) Boxcar for loudspeaker bobbin

(76) Inventors: David J. Michno, Carson City, NV (US); Robert M. Smith, Gardenerville, NV (US); David J. Graebener, Reno, NV (US); Jack T. Bohlender, Carson City, NV (US)

Correspondence Address: RICHARD C. CALDERWOOD, 2775 NW 126TH AVE, PORTLAND, OR, 97229-8381, US

(21) Appl. No.: 11/636,299

(22) Filed: Dec. 7, 2006

(51) Int. Cl. H04R 1/00

(52) U.S. Cl. 381/407; 381/423

(57) ABSTRACT

An electromagnetic transducer such as an audio loudspeaker, whose diaphragm assembly and motor both have a highly elongated shape in which the long dimension is at least 3× greater than the short dimension. The diaphragm may be obround, and the motor's magnetic air gap may comprise a pair of elongated, parallel, linear gaps. A novel “boxcar” device is used to hold the bobbin and voice coil in an obround shape, maintaining the parallel, linear shape of their elongated sides. The lower suspension may be disposed only at the ends of the motor, enabling the narrowest possible configuration.

### RELATED APPLICATION

This application shares a common specification with U.S. patent application Ser. No. ______ entitled “Highly Elongated Loudspeaker and Motor” filed simultaneously by the present inventors and co-inventor Thilo Christian Stompler. Both applications are assigned to the same assignee, Wisdom Audio Corporation.

### BACKGROUND OF THE INVENTION

1. Technical Field of the Invention

This invention relates generally to loudspeakers and their motors, and more specifically to a motor and loudspeaker which have a highly obround (or “racetrack”) shape.

2. Background Art

An electromagnetic transducer style loudspeaker includes a motor coupled to a diaphragm assembly, typically by a frame. Loudspeaker diaphragms are known in a variety of shapes, referring to their outer perimeter, for example circular or “round”, elliptical, rounded square (that is, a square with rounded corners), and obround or “racetrack”. The obround shape is defined by a pair of semicircles connected by two parallel lines tangent to their endpoints.

Loudspeaker motors are most commonly circular, but are occasionally seen in other shapes, such as the elongated, tubular motor shown in U.S. patent application Ser. No. 10/423,726 by Enrique Stiles.

The shape and size of a loudspeaker may sometimes be dictated by the engineering aspects of a particular application, rather than by mere aesthetic desires. For example, an 18″ diameter circular subwoofer will not easily be fitted to an automobile's rear deck which measures only 10″ deep, and a 6″×9″ elliptical midbass driver cannot readily be fitted to a home theater loudspeaker tower cabinet measuring only 5″ across.

In addition to the limitations imposed by the dimensions of the diaphragm and/or frame, additional limitations may often be imposed by the dimensions of the motor itself. The 5″ wide tower cabinet will not hold a 4″×12″ obround woofer, even though the frame and diaphragm would fit, if the woofer is driven by a circular motor measuring 8″ across. But it may not be acceptable to fit a 4″ motor to that woofer's diaphragm assembly, because the smaller motor may typically lack the power necessary to produce sufficient sound pressure and quality.

A few manufacturers have fitted their elongated loudspeaker with a row of multiple small motors. This is problematic, in that it significantly raises the cost of goods sold, and in that the loudspeaker will often not perform well, such as if the motors are not perfectly matched in power, throw, suspension, impedance, and so forth.

Different sizes of loudspeakers—for example tweeters versus subwoofers—generally call for different sizes of motors. Existing motor designs do not scale particularly well. For example, a 1″ diameter round tweeter may have a 1.5″ diameter round motor and a 1″ diameter voice coil, and a 6″ diameter round mid-bass driver may have a motor which is roughly 6″ in diameter and a 2″ voice coil, but a 15″ diameter subwoofer will typically have a motor that is roughly 8″ in diameter and a 3″ diameter voice coil.

What is needed is a new motor geometry which lends itself to powering a highly elongated (obround or otherwise) loudspeaker with a single motor, suitable to be used in narrow, thin enclosures of small volume. What is further needed is such a loudspeaker having a very large voice coil, large and powerful motor assembly, and robust mechanical construction, enabling the loudspeaker to be equalized to produce very deep bass frequencies in such an enclosure.

### BRIEF DESCRIPTION OF THE DRAWINGS

FIG. 1 shows a perspective view of one embodiment of a loudspeaker according to this invention.

FIG. 2 shows the loudspeaker of FIG. 1 in cutaway view.

FIG. 3 shows a perspective view of one embodiment of a loudspeaker motor such as may be used in the loudspeaker of FIG. 1.

FIG. 4 shows a cross-sectioned view of the motor of FIG. 3.

FIG. 5 shows an exploded view of the motor and the lower suspension components.

FIG. 6 shows a perspective view of the voice coil assembly of the motor of FIG. 3.

FIG. 7 shows an exploded view of the voice coil assembly of FIG. 6.

FIG. 8 shows a perspective view, from slightly underneath, of one embodiment of a boxcar bobbin constraining device such as may be used in the voice coil assembly of FIG. 6.

FIGS. 9 and 10 show an end view and a side view, respectively, of the boxcar of FIG. 8.

FIGS. 11-14 demonstrate one method of winding the voice coil onto the bobbin, using a mandrel to give them a shape which is different than the shape in which the boxcar holds them.

FIG. 15 shows a perspective view of the spider mounting lug used to couple the bobbin assembly to the lower suspension components.

FIG. 16 shows a perspective view of the spider used in the lower suspension.

FIG. 17 shows a cutaway view of the surround or upper suspension component.

FIGS. 18-21 show perspective views of highly elongated diaphragms having obround, elliptical, rounded rectangle, and rectangular shapes, respectively.

FIG. 22 shows a cutaway view of a loudspeaker using a highly elongated induction motor.

FIG. 23 shows a cutaway view of a highly elongated loudspeaker motor having curved magnetic air gaps.

### DETAILED DESCRIPTION

The invention will be understood more fully from the detailed description given below and from the accompanying drawings of embodiments of the invention which, however, should not be taken to limit the invention to the specific embodiments described, but are for explanation and understanding only.

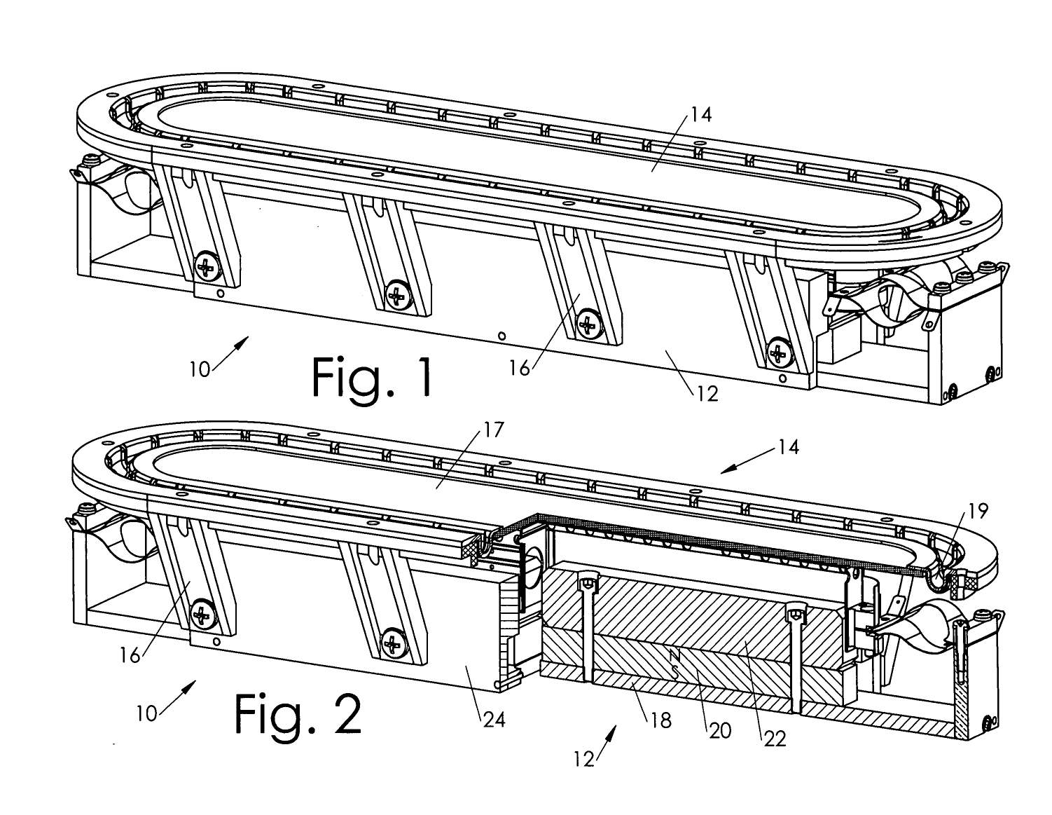

FIG. 1 illustrates a highly elongated loudspeaker 10 having a highly elongated motor 12 coupled to a highly elongated diaphragm assembly 14 by a frame 16, according to one embodiment of this invention. The diaphragm assembly and frame are optionally, but advantageously, of an obround shape. In other embodiments, they may have other highly elongated shapes.

A highly elongated shape may be characterized as one which has a long dimension at least three times as great as its short dimension, when viewed in a direction coaxial with the axis of movement of the motor and diaphragm assembly. In one embodiment, the diaphragm itself has a long dimension of 14.9″ and a short dimension of 2.9″.

The diaphragm assembly includes a diaphragm 17 coupled to the frame by an upper suspension component such as an inverted surround 19. In one embodiment, the diaphragm is based on an aluminum honeycomb, which provides excellent strength and stiffness, and also serves to wick heat from the motor side to the listening space side, to cool the loudspeaker. And because of its flat shape, the aluminum honeycomb also lends itself for use in in-wall, in-ceiling, and other applications in which it is important to limit the overall depth of the loudspeaker.

FIG. 2 illustrates the loudspeaker 10 in cutaway view, showing some details of the motor 12 and the diaphragm assembly 14. The motor includes a back plate 18, atop which is magnetically coupled an axially charged magnet 20. A center pole 22 is magnetically coupled atop the magnet. A first side yoke plate 24 is magnetically coupled to the back plate at a first side of the back plate, and a second side yoke plate (not visible) is magnetically coupled to the back plate at a second, opposite side. The back plate and side plates together form a U-shaped yoke. The side plates and the center pole define a magnetic air gap (not visible). In the embodiment shown, the magnetic air gap includes two long, parallel channels extending in the long dimension of the loudspeaker, and the end regions of the motor are used for suspension rather than magnetic air gap. In other embodiments, the magnetic air gap may have other elongated shapes.

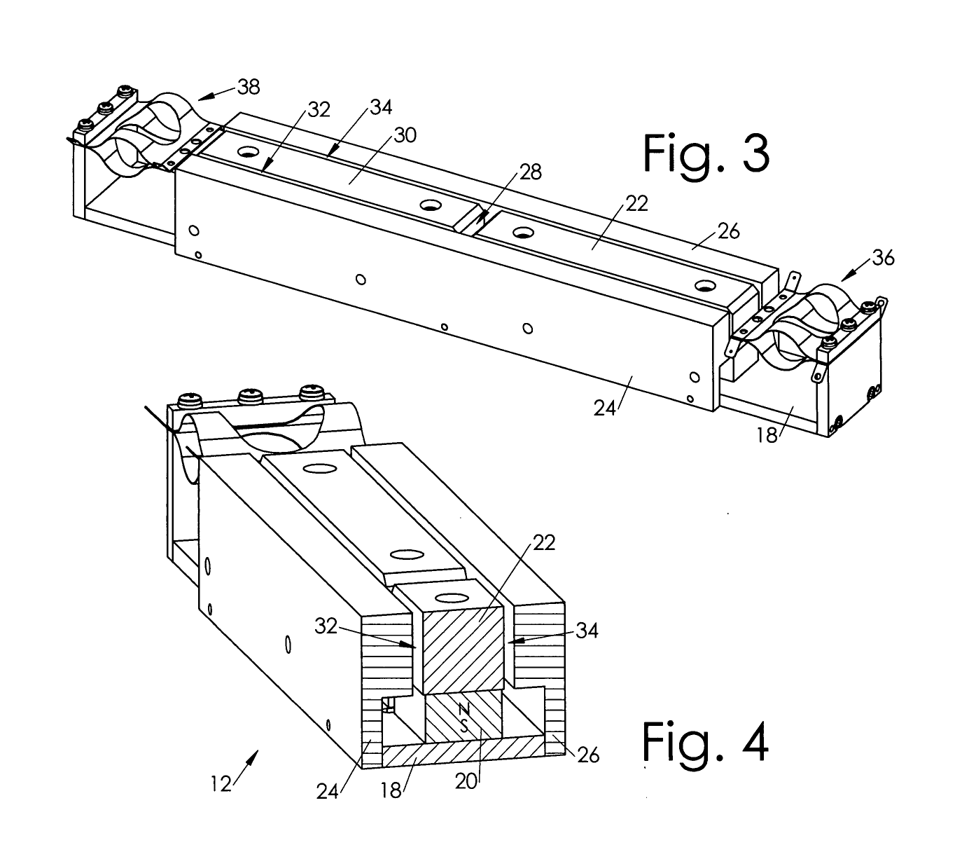

FIG. 3 illustrates a perspective view of the motor structure 12, with its back plate 18, first side plate 24 and second side plate 26. In the embodiment shown, the magnets (not visible) and the center pole are each split into two sub-components (to provide a clearance zone 28 for a bobbin stiffener which is visible in FIG. 2 and which will be discussed below). The center pole includes a first center pole piece 22 and a second center pole piece 30. The center pole pieces and the first and second side plates define a pair of elongated, parallel magnetic air gap regions 32, 34.

At the ends of the motor, there is no magnetic air gap in this particular arrangement. Instead, those regions of the motor are used to provide attachment and clearance for lower suspension components 36, 38.

FIG. 4 illustrates the motor 12 in cross-section, showing the back plate 18, the side plates 24, 26 which are magnetically coupled to the back plate, the magnet 20 which is magnetically coupled to the back plate, and the center pole 22 which is magnetically coupled to the magnet and which defines the magnetic air gaps 32, 34 with the side plates. In the embodiment shown, the side plates are mated to the outer surfaces of the back plate, but in other embodiments, they could be mated to its upper surface, or otherwise configured. In the embodiment shown, each side plate includes a lower portion which mates with the back plate, and an upper portion which extends inward to define the magnetic air gap.

In other embodiments, the motor may have a T-shaped monolithic back plate and center pole component, or even an E-shaped monolithic back plate, center pole, and side plate component, and a pair of oppositely charged magnets (one polarized N-S in the left-right direction in the drawing, and the other polarized S-N) may be coupled to opposite faces of the center pole, or to opposing faces of the side plates, to define the magnetic air gap.

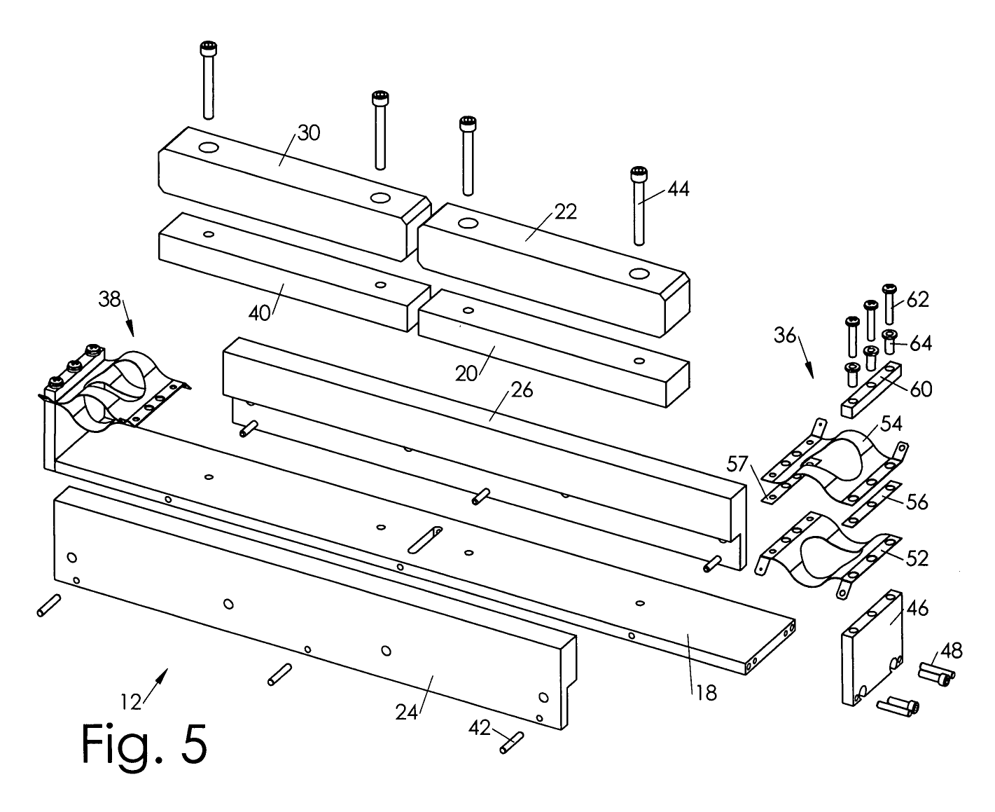

FIG. 5 illustrates an exploded view of the motor 12 and the first lower suspension 36. The magnetic circuit of the motor includes the back plate 18, the side plates 24, 26, the magnets 20, 40, and the center poles 22, 30. In one embodiment, the side plates are coupled to the back plate with pins, bolts, screws, or other suitable fasteners 42, and the center poles and magnets are coupled to the back plate with magnetically non-conductive (e.g. stainless steel) fasteners 44. For clarity in the illustration, the various holes are not numbered.

The motor further includes the end plates 46 which are coupled to the back plate (or, alternatively, to the end plates) by fasteners 48. The end plates provide structural support for the lower suspension components.

In one embodiment, the lower suspension components include a first spider 52 and a second spider 54, which have their suspension rolls oriented in opposite directions, to improve the upward vs. downward symmetry of the suspension's compliance and thereby reduce some forms of harmonic distortion. In one embodiment, the spiders serve as the electrical voice signal conduction means, carrying the voice signal from the external source (not shown) to the voice coil (not shown). In one such embodiment, the +voice signal is injected via the spider(s) at a first end of the motor, and the − voice signal is injected via the spider(s) at a second end of the motor. In another embodiment, the + and − voice signals are injected at the same end of the motor, each via its own, dedicated spider, in which case the spiders are separated by insulating strips 56, 57 to prevent a short circuit. The spiders may be coupled to the end plate by a mounting block 60 held down by fasteners 62. In embodiments where the mounting block is electrically conductive, the fasteners may be equipped with insulating shoulder washers or sleeves 64 which extend through the mounting block and the spiders, and/or the fasteners may be formed of an electrically non-conductive material.

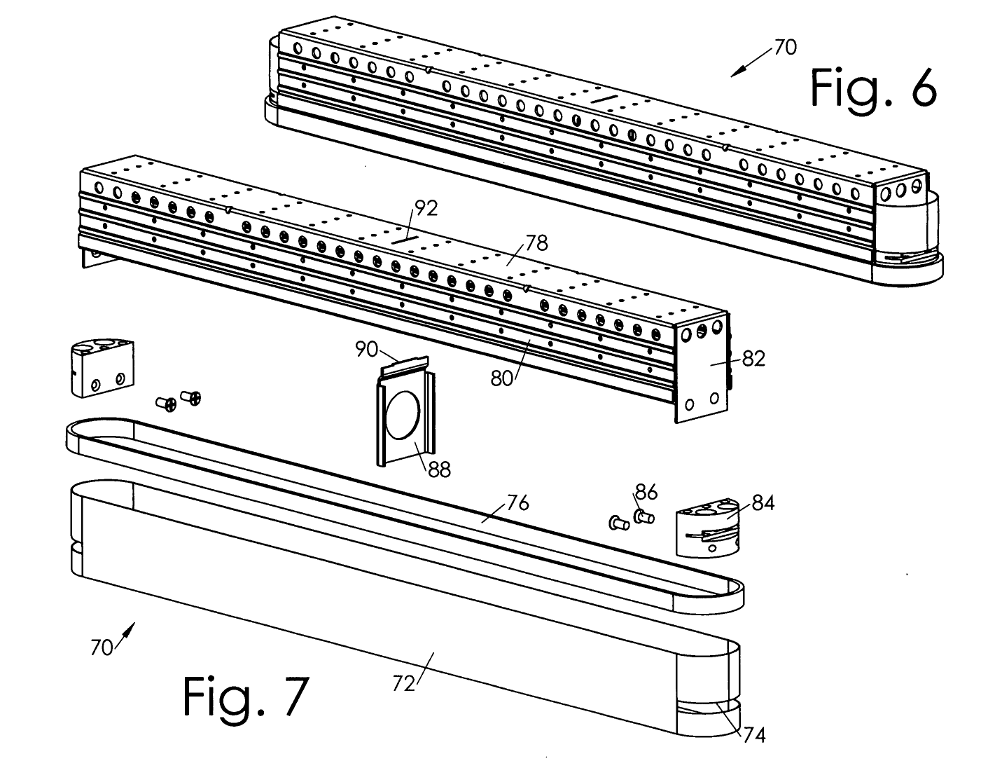

FIGS. 6 and 7 illustrate, respectively, a perspective view and an exploded view of one embodiment of a voice coil assembly 70 such as may be used in conjunction with the motor of FIG. 3. The voice coil assembly includes a bobbin 72 which may include a slot 74 for suspension attachment. A voice coil 76 (either an active, multi-winding voice coil or a shorted turn, depending on the motor) is coupled to the bobbin. For ease of illustration only, the voice coil is illustrated as a simplified single turn; in practice, it may include any number of layers of any number of windings of suitable gauge wire. A boxcar style bobbin constraining device 78 is coupled to the bobbin and serves to constrain the assembly to a predetermined shape, as will be discussed below. In one embodiment, the boxcar includes rigid side portions 80 which fit snugly against the outside surface of the elongated portions of the bobbin, and end portions 82 for providing suspension mounting.

Spider mounting blocks 84 fit snugly inside each end of the bobbin and are coupled to the ends of the boxcar by screws 86 or other suitable means. In some very elongated embodiments, it may be desirable to provide the moving parts assembly with a bobbin stiffening spacer 88 which fits snugly within the bobbin, pressing the bobbin against the sides of the boxcar, to keep the voice coil in the desired shape (in this case, parallel straight lines). The spacer may include a tab 90 which mates with a slot 92 on the boxcar, to provide positive retention and positioning.

In one embodiment, the bobbin is constructed of anodized aluminum, the spider mounting blocks are constructed of machined phenolic or injection molded plastic, the spacer is constructed of aluminum or other suitably rigid material, and the boxcar is constructed of aluminum or other suitably rigid material. In one embodiment, the end portions of the boxcar are not in direct contact with the side portions of the boxcar, to prevent the existence of, in essence, a shorting ring. In other embodiments, the boxcar is deliberately constructed so as to create a shorting ring.

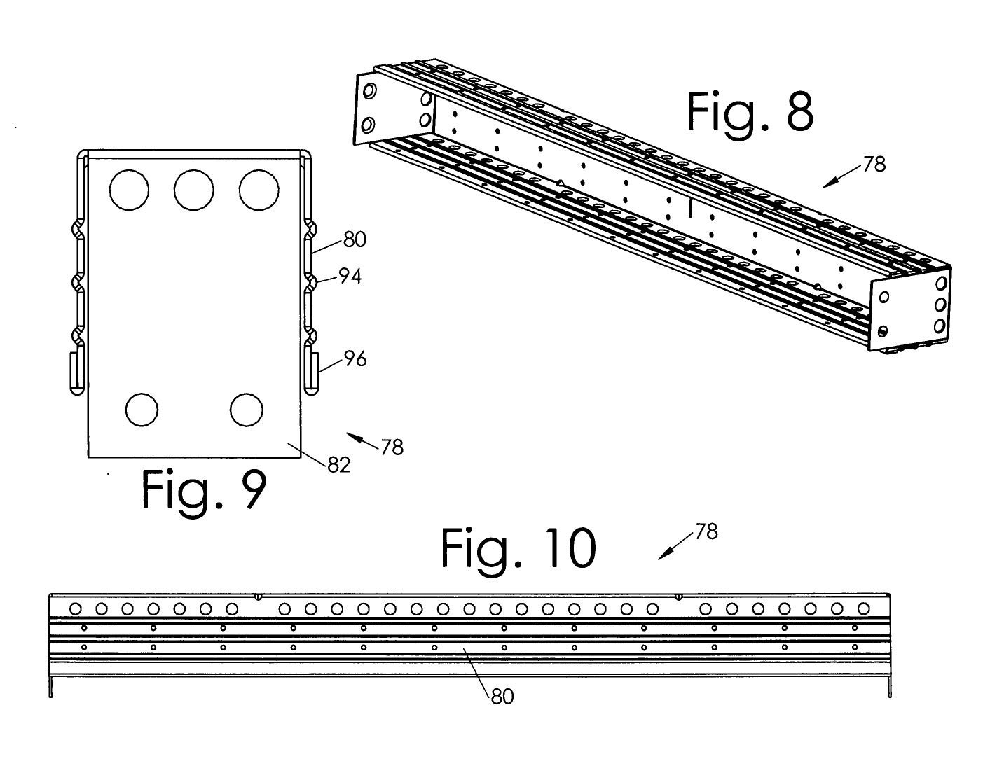

FIGS. 8, 9, and 10 illustrate the boxcar 78 in perspective view from the bottom, in end view, and in side view, respectively, showing the sides 80 and ends 82 of the boxcar.

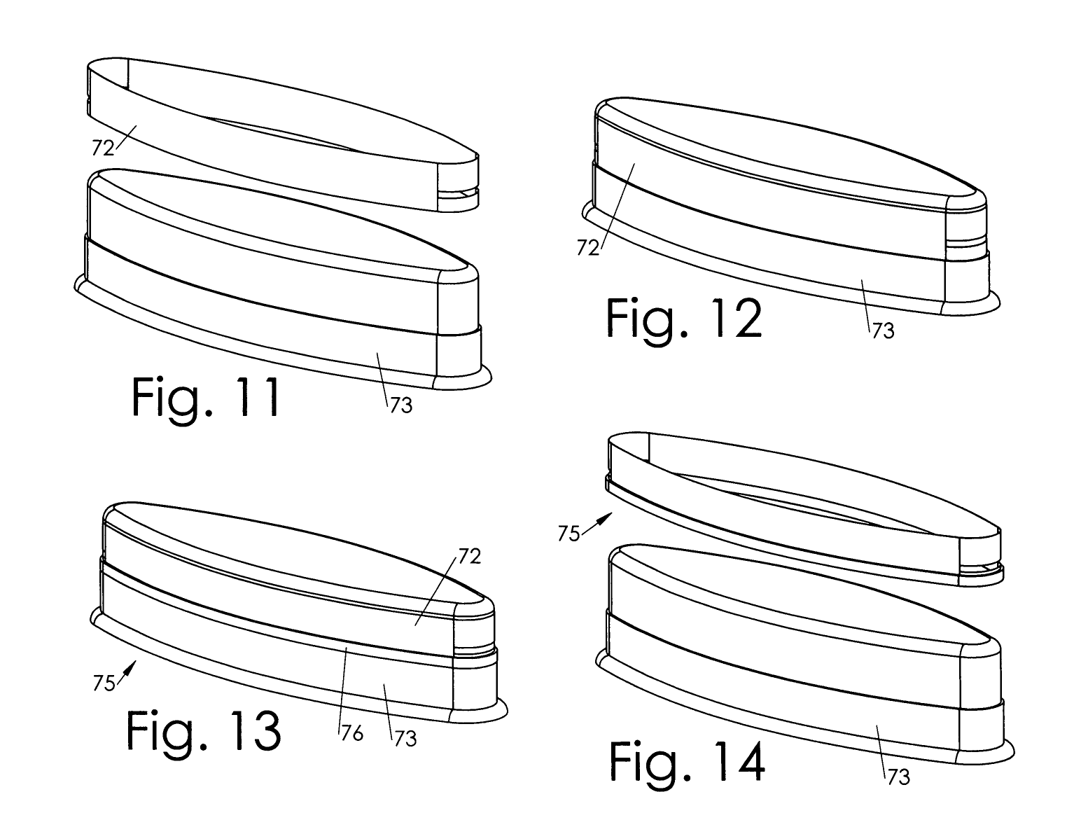

FIGS. 11-14 illustrates one method of coupling the voice coil 76 to the bobbin 72 using a mandrel, fixture, or jig 73 to give the assembly an intermediate shape. If the bobbin were held in its ultimate obround shape during winding of the voice coil, it would be very difficult to keep the elongated side portions of the voice coil in solid contact with, and pressure on, the elongated side portions of the bobbin, due to the lack of convex curvature in those regions. In order to make the winding of the voice coil easier, more efficient, and more effective, the bobbin may be held in an elliptical shape, as shown, during the winding, by placing it over an elliptical jig. After the voice coil is wound, and optionally after the adhesive is cured, the assembly is removed from the jig.

Then, when the voice coil assembly (of FIGS. 7 and 8) is assembled, the bobbin and voice coil are stretched into their desired obround shape, and the boxcar is placed over the bobbin. The rigid sides of the boxcar keep the bobbin and voice coil in the obround shape. The lateral ridges 94 and the doubled-over lower end 96 of the side portions of the boxcar (seen in FIG. 9) provide improved lateral rigidity, improving the boxcar's ability to keep the bobbin and voice coil in the desired obround shape, even if the bobbin and voice coil exhibit shape memory pressure against the side portions of the boxcar.

It should be noted that the voice coil 76 may be a conventional multi-winding voice coil of any suitable number of layers, and having ends (not shown) to which the alternating current voice signal is applied. Alternatively, the voice coil may be one or more shorted turns, suitable for use in an induction motor.

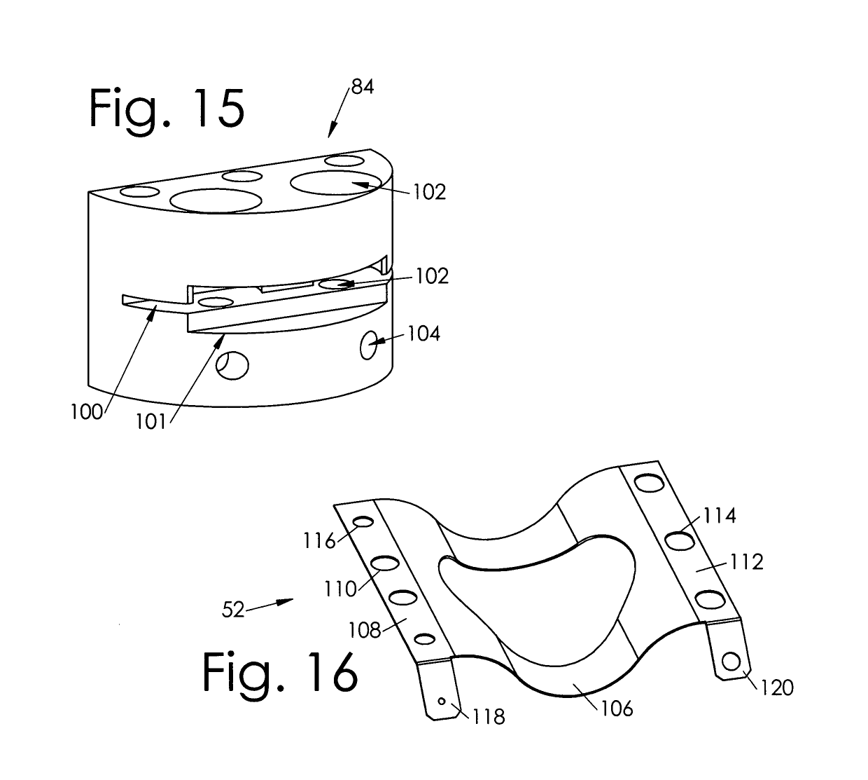

FIG. 15 shows the spider mounting lug 84 in greater detail. The spider mounting lug has a body adapted with a slot 100 into which the spider fits, and holes 102 through which bolts or screws (not shown) can be inserted to provide positive retention and positioning of the spider. Holes 104 are provided for bolts or screws (not shown) to affix the spider mounting lug to the boxcar. The slot 100 may, in some embodiments, be modified with a wider outer portion 101 to provide vertical clearance to allow for deflection of the spiders during extreme displacement of the diaphragm assembly.

FIG. 16 shows one embodiment of a spider 52 (or 56) such as may be used in the loudspeaker described above. The spider includes a central portion 106 which provides the suspension characteristics of the spider, and which may have any desired shape, per the needs of the application at hand. The spider includes a first end portion 108 adapted with holes 110 for coupling to the spider mounting lug of FIG. 15, and a second end portion 112 adapted with holes 114 for coupling to the motor or frame of the loudspeaker. The second end is, thus, the fixed position end, and the first end is the reciprocating end which moves with the diaphragm assembly.

In some embodiments, the spider is formed of an electrically conductive material such as metal or carbon fiber, and serves double duty as the voice signal connection means. In such embodiments, the first end portion may be adapted with holes 116 for connection to the ends (not shown) of the voice coil (whether a moving voice coil coupled to the bobbin, or a fixed primary coil in the case of an induction motor); alternatively, the spider may be adapted with a car audio male spade connector or other suitable electrical connector 118 to which the voice coil wire may be connected. The second end portion of the spider may be adapted with a connector 120 to which the external speaker wire (not shown) from the amplifier may be fastened.

In some embodiments, it may be desirable to adapt the central suspension portion of the spider with one or more holes 122 for lightening the spider and/or for adjusting its suspension characteristics. In general, it is desirable to make the spider wide (in the direction of the short dimension of the loudspeaker, the direction generally from reference number 106 to reference number 122 in the drawing), to maximize the spider's ability to reduce voice coil rocking in that direction. Rocking in the long dimension will tend to be minimized both by the upper suspension component and by the greater moment arm of the moving parts in that direction than in the short direction.

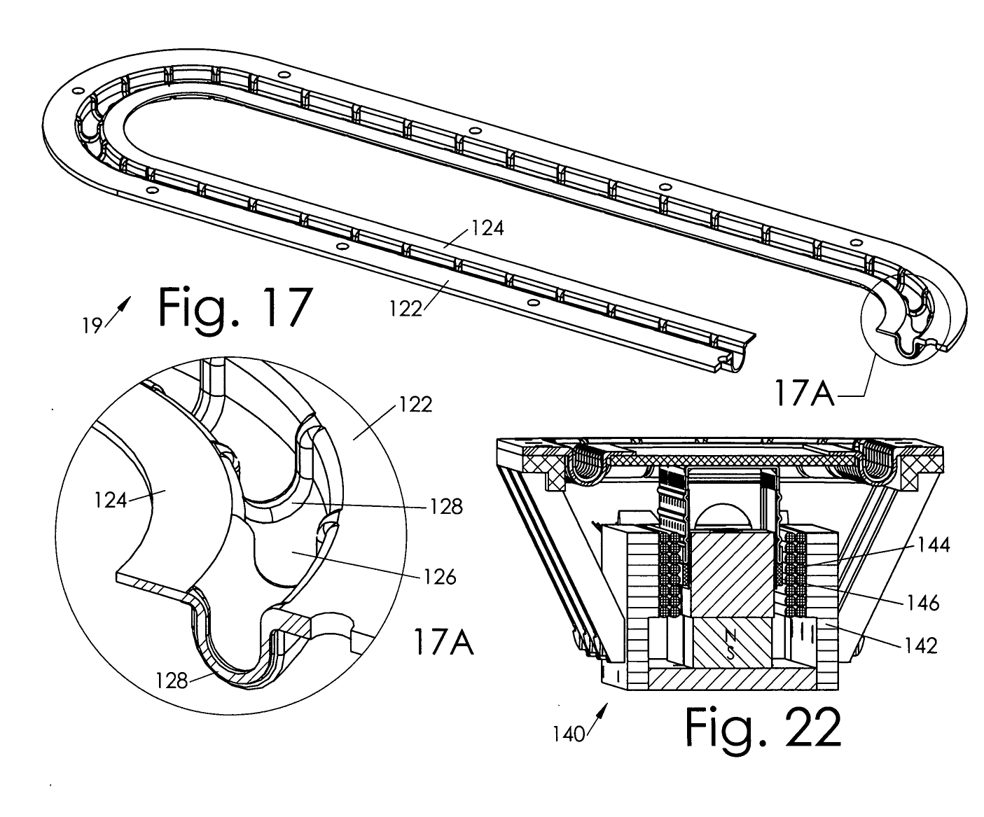

FIG. 17, with its detail view 17A, illustrates one embodiment of a surround 19 which may be used in the highly elongated loudspeaker of this invention. The surround includes an outer portion 122 configured for coupling to the frame (not shown), and an inner portion 124 configured for coupling to the diaphragm (not shown). The inner and outer portions are connected by a compliant suspension portion 126 which may take any suitable shape—in the example shown, an inverted roll. To enhance resistance to surround deformation, such as when operating under high pressure differentials created when using small enclosures with high power and extensive equalization, the suspension portion may include a plurality of hoops 128 whose thickness is greater than the suspension portions between them. In detail view 14A, the cross-section is taken directly through one of the hoops.

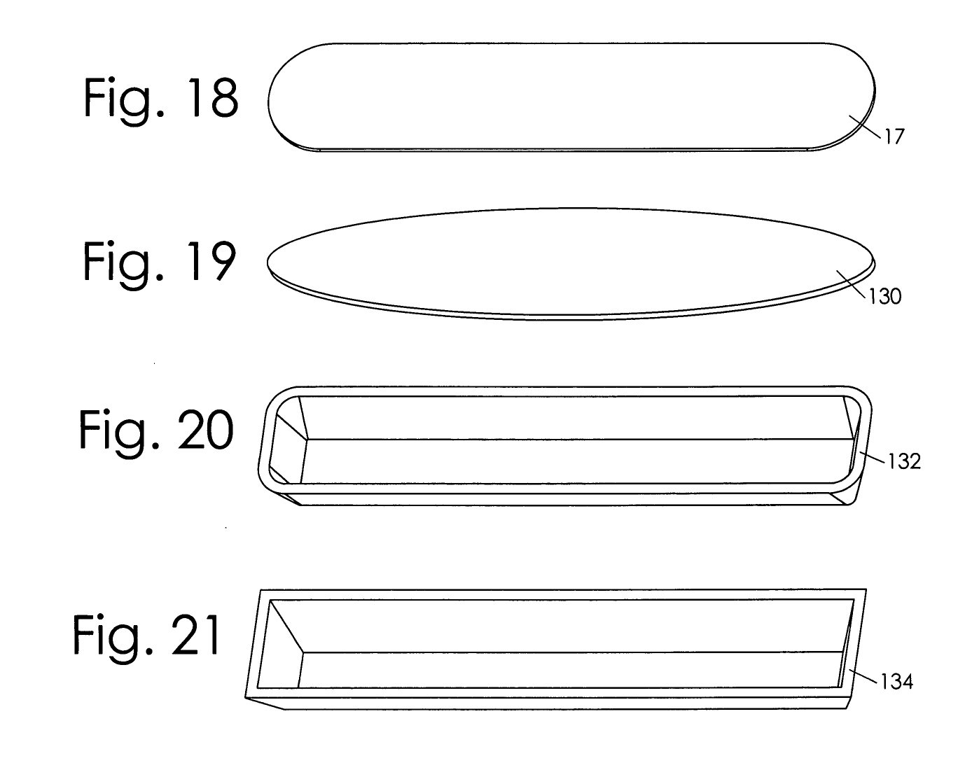

FIGS. 18-21 illustrate highly elongated diaphragms having obround, elliptical, rounded rectangle, and rectangular shapes, respectively. The invention may be practiced using diaphragms of other shapes, but these are perhaps the ones that will be most commonly advantageous.

The diaphragm may be constructed as a flat piston, as in FIGS. 18-19, or it may be constructed as a “cone”, as in FIGS. 20-21. In conical configurations, it will be desirable to have a dust cap (not shown) to seal the front side of the piston from the back side of the piston. The diaphragm may be constructed of any suitable material, such as paper, Kevlar, fiberglass, carbon fiber, aluminum, aluminum honeycomb, beryllium, injection molded plastic, composites, and so forth. Aluminum and other materials having good thermal conductivity are desirable, to improve thermal extraction to cool the voice coil assembly by conducting heat away to the listening space air.

FIG. 22 illustrates a highly elongated loudspeaker 140 in cross-sectioned end view, using an induction motor whose outer yoke plates 142 provide sufficient clearance in the magnetic air gap for the inclusion of a primary coil 144 to which the alternating current voice signal is applied. In the induction motor, the moving coil 146 is made of one or more shorted turns of e.g. aluminum.

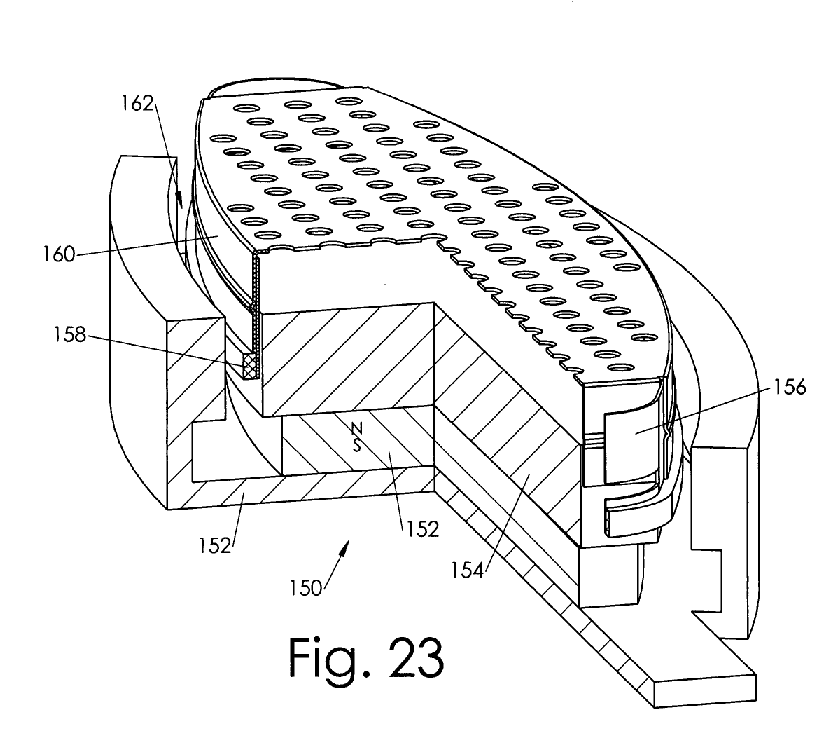

FIG. 23 illustrates another embodiment of a highly elongated loudspeaker motor 150. The motor has a long dimension which extends substantially in and out of the page, and a short dimension which extends substantially left to right on the page, and an axis which extends substantially vertically on the page. The motor includes a yoke 152, a permanent magnet 152, and a top plate or center pole 154. The yoke and center pole define a magnetic air gap 162 which has a curved shape, rather than the straight sides of an obround shape as illustrated in earlier drawings. A bobbin 156 carries a voice coil 158 and is coupled to a curve-sided boxcar 160.

### Examples of Obround Voice Coils

Table 1 shows the diameter, circumference, and area of the diaphragm (or effective piston radiating surface), the voice coil diameter and circumference, and the ratio of the voice coil circumference to piston circumference, for four exemplary, conventional, round loudspeakers and one conventional elliptical loudspeaker. It also shows those calculations for two obround loudspeakers comparable in piston area to each of the round loudspeakers.

TABLE 1
Voice Coil:Piston Ratios
ROUND diaphragm and voice coil - prior art

| | piston | piston | piston | v/c | v/c | v/c circ:piston | v/c circ:piston |
|---|---|---|---|---|---|---|---|
| | diam | circum | area | diam | circum | circ | area |
| tweeter | 1.00 | 3.14 | 0.79 | 1.00 | 3.14 | 1.00 | 4.00 |
| midrange | 5.00 | 15.71 | 19.63 | 1.50 | 4.71 | 0.30 | 0.24 |
| woofer | 8.00 | 25.13 | 50.27 | 2.00 | 6.28 | 0.25 | 0.13 |
| subwoofer | 12.00 | 37.70 | 113.10 | 3.00 | 9.42 | 0.25 | 0.08 |

ELLIPTICAL diaphragm and round voice coil - prior art

| | piston | piston | piston | piston | v/c | v/c | v/c circ:piston | v/c circ:piston |
|---|---|---|---|---|---|---|---|---|
| | long | short | circ | area | diam | circ | circ | area |
| midbass | 9.00 | 6.00 | 23.80 | 42.41 | 1.50 | 4.71 | 0.20 | 0.11 |

OBROUND diaphragm and voice coil

| | piston | piston | piston | piston | v/c | v/c | v/c | v/c circ:piston | v/c circ:piston |
|---|---|---|---|---|---|---|---|---|---|
| | straight | diam | circ | area | straight | diam | circ | circ | area |
| tweeter | 0.45 | 0.75 | 3.26 | 0.78 | 0.45 | 0.75 | 3.26 | 1.00 | 4.18 |
| | 1.16 | 0.50 | 3.89 | 0.78 | 1.16 | 0.50 | 3.89 | 1.00 | 5.01 |
| midrange | 4.25 | 3.00 | 17.92 | 19.82 | 3.25 | 2.00 | 12.78 | 0.71 | 0.65 |
| | 8.25 | 2.00 | 22.78 | 19.64 | 7.25 | 1.00 | 17.64 | 0.77 | 0.90 |
| woofer | 13.00 | 3.25 | 36.21 | 50.55 | 11.00 | 2.25 | 29.07 | 0.80 | 0.58 |
| | 16.25 | 2.75 | 41.14 | 50.63 | 14.25 | 1.75 | 34.00 | 0.83 | 0.67 |
| subwoofer | 18.75 | 5.00 | 53.21 | 113.38 | 15.75 | 4.00 | 44.07 | 0.83 | 0.39 |
| | 25.35 | 4.00 | 63.27 | 113.97 | 22.35 | 3.00 | 54.12 | 0.86 | 0.47 |

The round tweeter is defined as having the same voice coil perimeter as diaphragm perimeter, for example a dome tweeter whose voice coil is wound directly on the outer skirt of the dome. The midrange has a 5″ round diaphragm and a 2″ voice coil. The woofer has an 8″ round diaphragm and a 2.5″ voice coil. And the subwoofer has a 12″ round diaphragm and a 3″ voice coil. The elliptical midbass driver is a conventional 6×9 with a 1.5″ round voice coil.

Like the round tweeter, the obround tweeter has its voice coil wound directly on the skirt of its dome. The obround midrange, woofer, and subwoofer are defined to have mechanical limitations requiring:
(a) the short dimension of the voice coil (defined by the diameter of the round portion) to be 1″ smaller than the short dimension of the piston (for example, caused by the motor's side plate thickness); and
(b) the long dimension of the voice coil to be respectively 1″, 2″, and 3″ shorter than the long dimension of their diaphragms (for example the space requirements of the end-mounted spiders). This is in addition to the clearance that is purchased by the smaller diameter of the round portion.

Those are optional characteristics of the eight obround loudspeakers, not necessary limitations, and are used for illustration purposes only.

Three parameters are meaningful in the present analysis: (1) The circumference of the voice coil determines, in large measure, the “L” component of the BL measurement of the strength of the motor; the greater the L (length of coil in the magnetic air gap), the stronger the motor. The circumference of the voice coil also determines, in large measure, the ability of the voice coil to dissipate heat; the greater the L, the more voice coil there is to dissipate heat. (2) The effective radiating area of the piston determines, in large measure and for a fixed Xmax of the motor, the sound pressure level (SPL) that the loudspeaker can produce. The larger the piston, the louder the loudspeaker, and, generally, the lower the frequencies it can effectively reproduce. (3) The circumference of the piston determines the circumference of the upper suspension component, typically a single-roll surround.

The ratio of the voice coil circumference to piston area, and voice coil circumference to piston circumference, may be used as measurements of the ability of the loudspeaker to handle high power loads or, in other words, the thermal durability of the loudspeaker. The higher the ratio, the higher the thermal durability. These ratios will be referred to as the “piston circumference” and “piston area” ratios, with it implicit that the ratio compares them to the voice coil circumference.

Unfortunately, due to limitations imposed by conventional motor yoke and voice coil configurations, the thermal durability of conventional loudspeaker technology gets worse with increasing diaphragm size, even though it is in the larger loudspeakers that improved thermal durability is most needed.

The conventional tweeter naturally has a voice coil circumference to piston circumference ratio of 1.00:1, because the voice coil is wound directly on the skirt of the tweeter dome. (Note that minute details such as the slight difference due to voice coil wire diameter and number of layers, are ignored here, as they are not meaningful in the scale of these considerations.) The midrange has a ratio of 0.30:1, the woofer has a ratio of 0.25:1, and the subwoofer has a ratio of 0.25:1. The tweeter has a voice coil circumference to piston area ratio of 4.00:1, the midrange has a ratio of 0.24:1, the woofer has a ratio of 0.13:1, and the subwoofer has a ratio of 0.08:1. The conventional 6×9 elliptical speaker has circumference and area ratios of 0.20:1 and 0.11:1, respectively.

The obround loudspeaker examples shown, by way of contrast, have vastly improved ratios—both voice coil circumference to piston circumference ratios, and voice coil circumference to piston area ratios.

Two obround tweeters are illustrated, having differing degrees of elongation but essentially the same piston area as the round, conventional tweeter. Because their voice coils are wound on the skirts of their obround domes, their piston circumference ratios are 1.00:1, just like in the conventional tweeter. But, because of their obround voice coils, their piston area ratios are 4.18:1 and 5.01:1, an improvement over the 4.00:1 ratio of the conventional tweeter.

Two obround midrange loudspeakers are illustrated, with different degrees of elongation. They have piston circumference ratios of 0.71:1 and 0.77:1, as compared to the conventional, round midrange loudspeaker which has a ratio of merely 0.30:1. They have piston area ratios of 0.65:1 and 0.90:1, versus the round midrange's ratio of only 0.24:1.

Two obround woofers are illustrated, with different degrees of elongation. They have piston circumference ratios of 0.80:1 and 0.83:1, as compared to the conventional, round midrange loudspeaker which has a ratio of merely 0.25:1. They have piston area ratios of 0.58:1 and 0.67:1, versus the round midrange's ratio of only 0.13:1.

Two obround subwoofers are illustrated, with different degrees of elongation. They have piston circumference ratios of 0.83:1 and 0.86:1, as compared to the conventional, round midrange loudspeaker which has a ratio of merely 0.25:1. They have piston area ratios of 0.39:1 and 0.47:1, versus the round midrange's ratio of only 0.08:1.

### CONCLUSION

When one component is said to be “adjacent” another component, it should not be interpreted to mean that there is absolutely nothing between the two components, only that they are in the order indicated.

The various features illustrated in the figures may be combined in many ways, and should not be interpreted as though limited to the specific embodiments in which they were explained and shown.

Those skilled in the art, having the benefit of this disclosure, will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. An electromagnetic transducer comprising:
a highly elongated motor having a long motor dimension and a short motor dimension which form a plane substantially perpendicular to an axis of the motor, wherein the long motor dimension is at least 2 times as great as the short motor dimension, wherein the long motor dimension is a measure of a magnetic air gap of the motor and the short motor dimension is a measure of an overall mechanical structure of the motor; and
a highly elongated diaphragm assembly coupled to be driven by the motor and including,
1) a bobbin which has a first shape when in a relaxed configuration,
2) a boxcar bobbin constraining device holding the bobbin in a second shape which is different than the first shape,
3) a voice coil coupled to the diaphragm and disposed in the magnetic air gap and having a voice coil circumference (VCC), and
4) a diaphragm coupled to at least one of the bobbin and the boxcar, the diaphragm having (i) a piston circumference (PC) and (ii) an effective piston radiating area (Sd) having a long diaphragm dimension and a short diaphragm dimension which form a plane substantially perpendicular to the axis of the motor, wherein the long diaphragm dimension is at least 2.5 times as great as the short diaphragm dimension.

2. The electromagnetic transducer of claim 1 wherein:
PC>50 inches; and
VCC:PC>0.80:1.

3. The electromagnetic transducer of claim 1 wherein:
the diaphragm has an obround shape.

4. The electromagnetic transducer of claim 1 further comprising:
a frame; and
lower suspension components coupling the diaphragm assembly to one of the frame and the motor, wherein the lower suspension components are disposed only at first and second ends of the motor and at an elevation lower than the diaphragm.

5. The electromagnetic transducer of claim 1 wherein the motor comprises:
a U-shaped yoke of magnetically conductive material and including a back plate portion and two side portions,
a permanent magnet magnetically coupled to the back plate portion inside the U-shaped yoke, and
a center pole magnetically coupled to the magnet opposite the back plate portion,
wherein the center pole and the side portions form a pair of parallel magnetic air gaps.

6. The electromagnetic transducer of claim 5 wherein:
the bobbin and the diaphragm each includes a pair of parallel portions disposed within respective ones of the magnetic air gaps.

7. The electromagnetic transducer of claim 6 wherein:
the second shape comprises an obround shape.

8. The electromagnetic transducer of claim 7 wherein the diaphragm assembly further comprises:
a bobbin spacer disposed within the bobbin and the boxcar to prevent the parallel portions of the bobbin from deflecting inward toward each other.

9. The electromagnetic transducer of claim 7 wherein:
the voice coil has been wound onto the bobbin while the bobbin has been held in a shape different than the obround shape in which the boxcar holds the bobbin.

10. The electromagnetic transducer of claim 6 wherein:
the parallel portions of the bobbin are disposed within the boxcar.

11. The electromagnetic transducer of claim 9 wherein the diaphragm assembly further comprises:
a pair of spider mounting lugs each disposed in a respective end of the bobbin and adapted for coupling to a spider.

12. The electromagnetic transducer of claim 11 wherein the diaphragm assembly further comprises:
at least one spider coupled to each of the spider mounting lugs.

13. The electromagnetic transducer of claim 5 wherein:
the magnet comprises at least two magnets arranged along the long motor dimension, wherein an adjacent pair of the at least two magnets has between them a space; and
the center pole comprises at least two center pole pieces arranged along the long motor dimension, wherein an adjacent pair of the at least two center pole pieces has between them a space which is aligned with the space between the magnets.

14. The electromagnetic transducer of claim 1 wherein:
the long motor dimension is at least 4 times as great as the short motor dimension.

15. The electromagnetic transducer of claim 14 wherein:
the long motor dimension is at least 8 times as great as the short motor dimension.

16. The electromagnetic transducer of claim 1 wherein:
the long motor dimension is at least 60% the long diaphragm dimension.

17. The electromagnetic transducer of claim 16 wherein:
the long motor dimension is at least 80% the long diaphragm dimension.

18. The electromagnetic transducer of claim 1 wherein:
VCC>4 inches; and
VCC:Sd>0.40:1.

19. The electromagnetic transducer of claim 18 wherein:
VCC>4 inches; and
VCC:Sd>0.80:1.

20. The electromagnetic transducer of claim 1 wherein:
VCC>8 inches; and
VCC:Sd>0.40:1.

21. The electromagnetic transducer of claim 20 wherein:
VCC>8 inches; and
VCC:Sd>0.80:1.

22. The electromagnetic transducer of claim 1 wherein:
VCC>12 inches; and
VCC:Sd>0.40:1.

23. The electromagnetic transducer of claim 22 wherein:
VCC>12 inches; and
VCC:Sd>0.80:1.

24. The electromagnetic transducer of claim 1 wherein:
PC>20 inches; and
VCC:PC>0.40:1.

25. The electromagnetic transducer of claim 24 wherein:
PC>20 inches; and
VCC:PC>0.80:1.

26. The electromagnetic transducer of claim 1 wherein:
PC>35 inches; and
VCC:PC>0.40:1.

27. The electromagnetic transducer of claim 26 wherein:
PC>35 inches; and
VCC:PC>0.80:1.

28. The electromagnetic transducer of claim 1 wherein:
PC>50 inches; and
VCC:PC>0.40:1.

29. The electromagnetic transducer of claim 1 wherein:
PC>50 inches; and
VCC:PC>0.80:1.

30. A voice coil assembly for use in an electromagnetic transducer having an axis of diaphragm assembly motion, the voice coil assembly comprising:
a highly elongated bobbin having a long dimension at least 2 times its short dimension, the long and short dimensions being perpendicular to the axis;
a highly elongated voice coil coupled to the bobbin; and
a boxcar bobbin constraining device coupled to the bobbin to hold the bobbin in a desired shape.

31. The voice coil assembly of claim 30 wherein:
the boxcar holds the bobbin in an obround shape; and
the bobbin is disposed within the boxcar.

32. The voice coil assembly of claim 31 wherein:
the voice coil has been wound onto the bobbin while the bobbin was in a different shape, wherein the different shape is one of elliptical and circular.

33. The voice coil assembly of claim 31 further comprising:
spider mounting lugs coupled to one of the bobbin and the boxcar at ends of the voice coil assembly.

34. A method of assembling a voice coil assembly for use in an electromagnetic transducer, the method comprising:
while holding a bobbin in a first shape,
winding a voice coil onto the bobbin;
affixing the voice coil to the bobbin;
then deforming the voice coil and bobbin into a second shape, the second shape being longer in a long dimension and shorter in a short dimension than the first shape;
coupling the bobbin to a boxcar bobbin constraining device, the boxcar having an elongated shape including sides extending in the long dimension, wherein the sides have at least a portion of the second shape, whereby the bobbin is held in the second shape by the boxcar.

35. The method of claim 34 wherein:
the first shape is one of elliptical and round; and
the second shape is obround.

36. The method of claim 35 further comprising:
disposing a spacer within the bobbin and the boxcar to prevent elongated, parallel sides of the bobbin from deflecting inward toward each other.
